(19) United States
(12) Patent Application Publication
(10) Pub. No.: US 2020/0116915 A1
(43) Pub. Date: Apr. 16, 2020

(54) LIGHTING DEVICE

(71) Applicant: SHARP KABUSHIKI KAISHA, Sakai City (JP)

(72) Inventor: TETSUYA TAKASHIMA, Sakai City (JP)

(21) Appl. No.: 16/598,205

(22) Filed: Oct. 10, 2019

Related U.S. Application Data
(60) Provisional application No. 62/745,473, filed on Oct. 15, 2018.

(51) Int. Cl. F21V 8/00

(52) U.S. Cl. CPC G02B 6/0021

(57) ABSTRACT

A lighting device includes a light source, an accommodating member, a light guide member, and an elastic member. The accommodating member accommodates the light source. The accommodating member includes a bottom and a vertical wall projecting from an edge of the bottom on a front surface side of the bottom. The light guide member has a thin plate shape. The light guide member is disposed on the front surface side of the bottom and configured to guide light emitted by the light source. The elastic member has elasticity. The elastic member is disposed between the vertical wall and the light guide member. At least one of the vertical wall and the light guide member includes a fitting portion. The elastic member is fitted to the fitting portion.

### CROSS REFERENCE TO RELATED APPLICATION

This application claims priority from U.S. Provisional Patent Application No. 62/745,473 filed on Oct. 15, 2018. The entire contents of the priority application are incorporated herein by reference.

### TECHNICAL FIELD

The technology described herein relates to a lighting device.

### BACKGROUND ART

An example of a lighting device is described in WO 2012/093595. The lighting device includes an accommodating member and spacers. The accommodating member includes a bottom plate and side plates. The side plates project from the bottom plate on one surface side of the bottom plate such that the accommodating member has an opening on the one surface side and accommodates at least a light source and a light guide plate. The spacers include elastic members and maintain distances between the side plates and the light guide plate, respectively. The spacers are disposed at corners between the adjacent side plates. Therefore, the light guide plate is positioned with a simple configuration.

In the production of the lighting device having the configuration, an end portion of a light guide member may be pressed against the elastic members and the light guide member may be accommodated while compressing the elastic member. To accommodate the light guide member in the accommodating member, the elastic members having a certain size may be required. Namely, it may be difficult to slim a bezel of the lighting device.

### SUMMARY

The technology described herein has been completed based on the above circumstances. An object is to provide a lighting device that can contribute to bezel sliming. Another object is to provide a lighting device including light guide member properly accommodated in an accommodating member.

A lighting device includes a light source, an accommodating member, a light guide member, and an elastic member. The accommodating member configured to accommodate the light source, the accommodating member accommodates the light source. The accommodating member includes a bottom and a vertical wall projecting from an edge of the bottom on a front surface side of the bottom. The light guide member has a thin plate shape. The light guide member is disposed on the front surface side of the bottom and configured to guide light emitted by the light source. The elastic member having elasticity is disposed between the vertical wall and the light guide member. At least one of the vertical wall and the light guide member includes a fitting portion. The elastic member is fitted to the fitting portion.

According to the technology described herein, the lighting device that can contribute to bezel sliming is provided. Furthermore, the lighting device including the light guide member properly accommodated in the accommodating member is provided.

### BRIEF DESCRIPTION OF THE DRAWINGS

FIG. 1 is a plan view of a lighting device according to a first embodiment viewed from a front surface side.

FIG. 2 is an exploded perspective view illustrating the lighting device.

FIG. 3 is an enlarged plan view of a convex portion in the lighting device.

FIG. 4 is an enlarged plan view of an elastic member.

FIG. 5 is an enlarged cross-sectional view of the lighting device (a cross section taken along line A-A in FIG. 4).

FIG. 6 is an enlarged cross-sectional view of a lighting device according to a second embodiment.

FIG. 7 is a plan view of a lighting device according to a first modification viewed from a front surface side.

FIG. 8 is an exploded perspective view illustrating a lighting device according to a second modified example.

### DETAILED DESCRIPTION

### First Embodiment

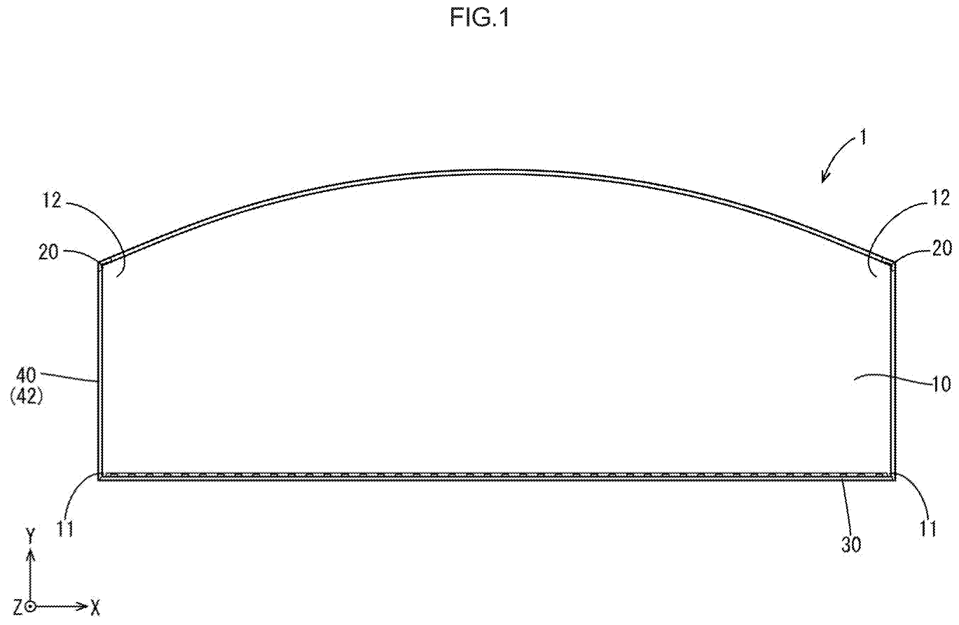

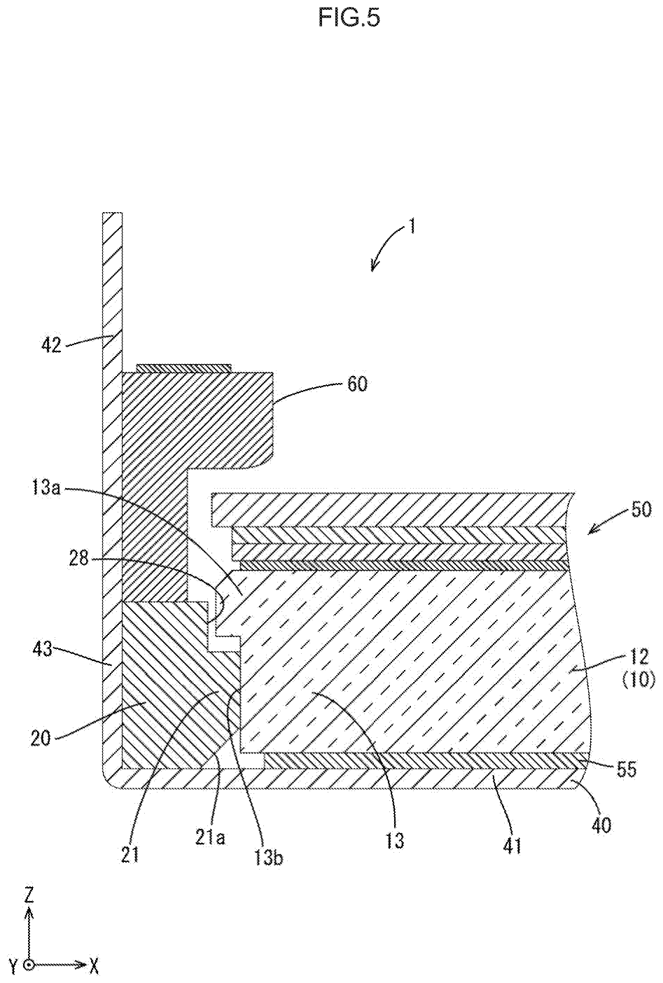

A first embodiment will be described with reference to FIGS. 1 to 5. In the following description, in a lighting device 1, a longitudinal direction is an X-axis direction, a lateral direction is a Y-axis direction, and a direction perpendicular to an X-Y plane is a Z-axis direction. In addition, with reference to FIG. 5, an upper side in the Z-axis direction is a front surface side, and a lower side is a back surface side.

The lighting device 1 is used in a liquid crystal display device provided on an inner panel of a vehicle in the present example, and is disposed on a back side of a liquid crystal panel so as to face the liquid crystal panel. As illustrated in FIG. 1, the lighting device 1 has an outer shape formed by a short side extending in the Y-axis direction on the left and right sides, a long side extending in the X-axis direction on a lower side, and a curve extending in the X-axis direction while bending in a round shape upward at the center, and has a hog-backed shape in plan view.

The lighting device 1 includes a light source 30 disposed along the X-axis direction on a lower long side, a light guide member 10 of a thin plate shape and a hog-backed shape in plan view disposed above the light source 30, and a chassis (accommodating member) 40 that accommodates the light source 30 and the light guide member 10 inside. The lighting device 1 is an edge light type in which light emitted from the light source 30 enters from the side of the light guide member 10. The light guide member 10 is disposed on a front surface side of a bottom 41 (described later) of the chassis 40 and guides the light emitted from the light source 30. As a material of the light guide member 10, a transparent synthetic resin material (for example, an acrylic resin such as PMMA or polycarbonate) is employed, and a refractive index is sufficiently higher than that of air.

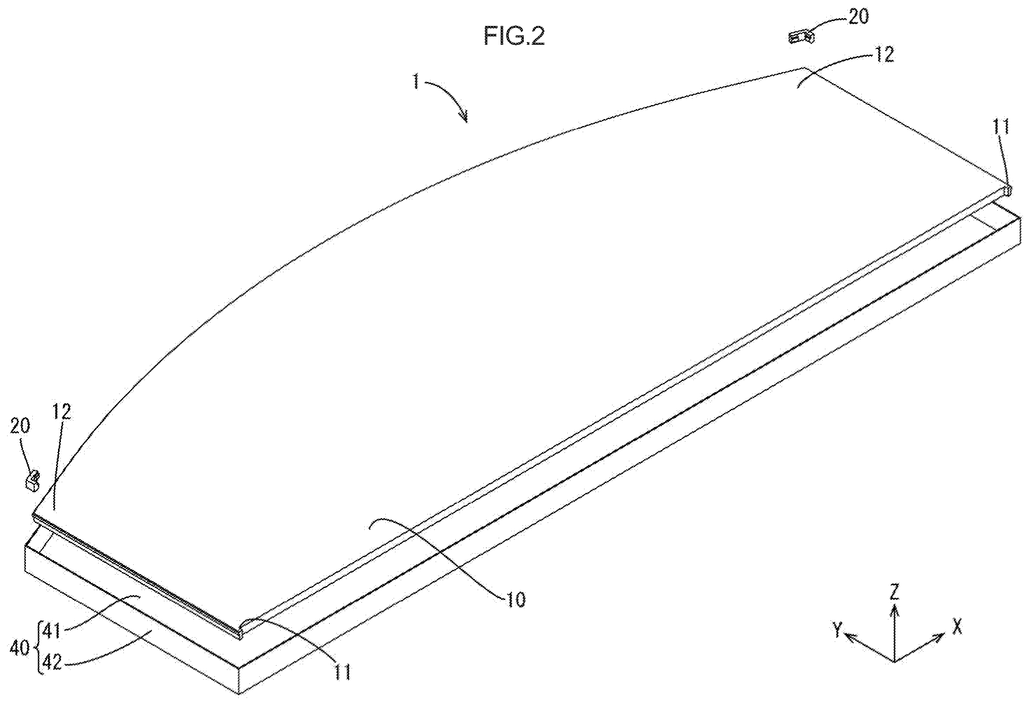

As illustrated in FIG. 2, the chassis 40 has a box shape with an opened top, and includes a bottom 41 that forms a bottom portion, and a vertical wall 42 that projects from an edge of the bottom 41 on the front surface side and forms a side wall. As illustrated in FIGS. 1 and 2, on an upper left corner and an upper right corner of the lighting device 1, elastic members 20 and 20 having elasticity made of rubber, urethane, or the like are disposed between the vertical wall 42 and the light guide member 10.

The lighting device 1 is manufactured by pressing-fitting the light guide member 10 until the light guide member 10 abuts on the bottom 41 (up to a back side) while elastically deforming the elastic members 20 and 20 between the vertical wall 42 and the light guide member 10, after the light guide member 10 is disposed on the front surface side of the bottom 41 of the chassis 40.

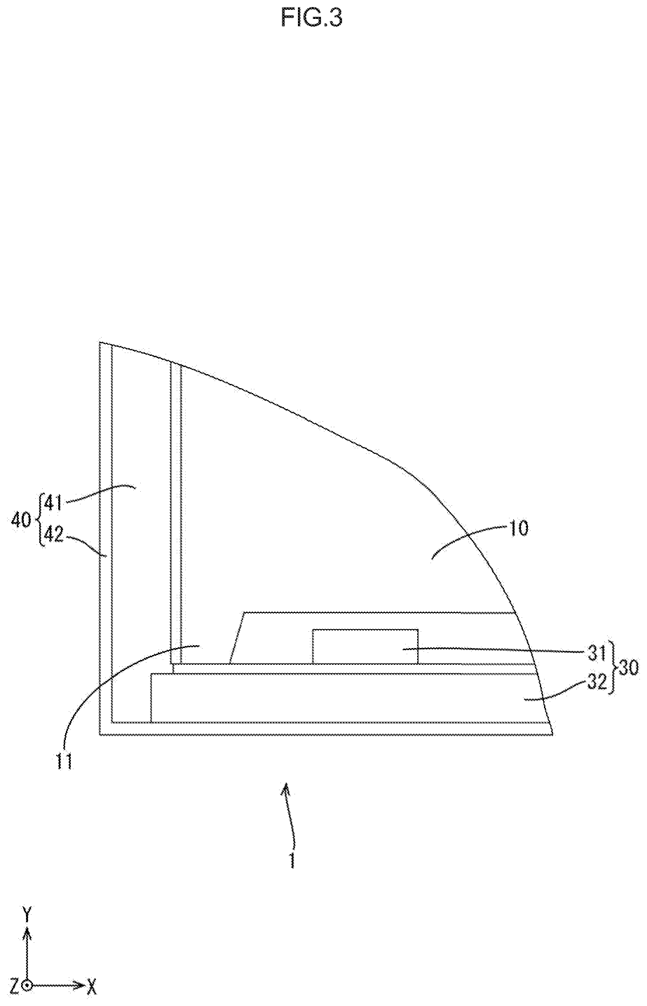

As illustrated in FIGS. 1 and 3 (a plan view in which the lower left portion of the lighting device 1 is enlarged), the light source 30 has an LED 31 that generates white light and an LED substrate 32 on which a plurality of LEDs 31 are arranged at equal intervals. The light guide member 10 has convex portions 11 and 11 protruding toward the light source 30 at lower right portion and a lower left portion. By the convex portions 11 and 11, a predetermined space is provided between the LED 31 and the light guide member 10.

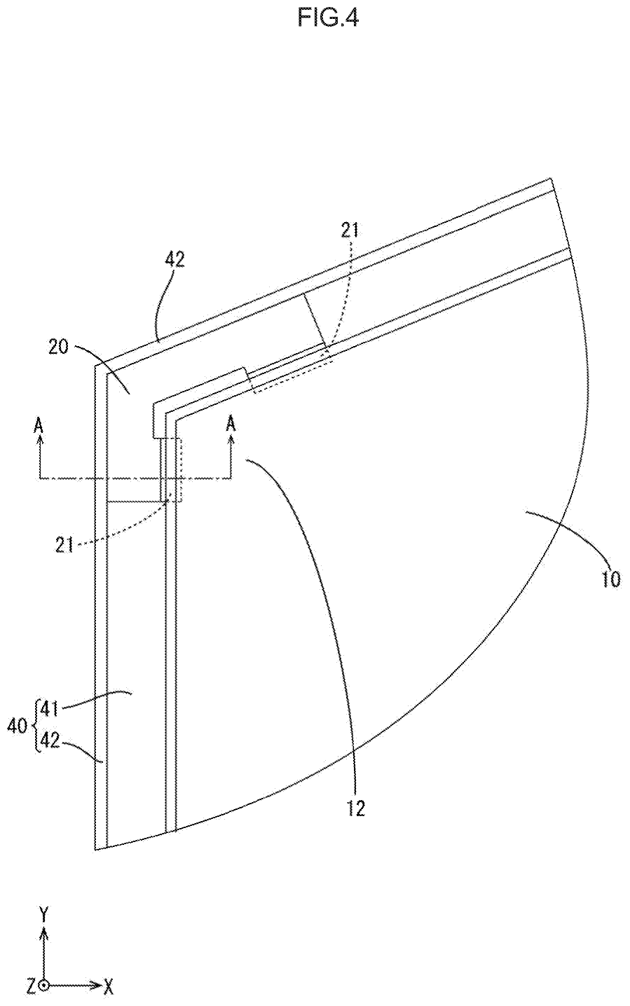

As illustrated in FIGS. 1 and 4 (a plan view in which the upper left portion of the lighting device 1 is enlarged), the elastic members 20 and 20 are respectively disposed one by one between an upper left corner 12 of the light guide member 10 and an upper left vertical wall 42, and between an upper right corner 12 of the light guide member 10 and an upper right vertical wall 42. As a result, even if vibration is applied to the lighting device 1 or each member of the lighting device 1 is thermally expanded, the elastic members 20 and 20 are elastically deformed, that a distance between the chassis 40 and the light guide member 10 can be suitably maintained. The elastic members 20 and 20 are disposed on the opposite side of the convex portions 11 and 11 in the Y-axis direction.

As illustrated in FIG. 4, the elastic member 20 is bent so as to follow an outer shape of the corner 12 of the light guide member 10. At both end portions of the elastic member 20, on a back surface side (the bottom 41 side of the chassis 40), extending portions 21 and 21 extending toward the inside of the corner 12 of the light guide member 10 (toward a recessed portion 13b of a fitting portion 13 described later in FIG. 5) are disposed.

FIG. 5 is a cross-sectional view illustrating a cross section taken along line A-A of FIG. 4. On the front surface side of the bottom 41, a reflection sheet 55, a light guide member 10, and an optical sheet 50 including a plurality of sheets are laminated in this order. The elastic member 20 is fixed by a frame 60 disposed on the front surface side thereof. It is to be noted that in FIGS. 1 to 4, illustration of the optical sheet 50, the reflection sheet 55, and the frame 60 is omitted.

The elastic member 20 has a recessed portion 28 that is recessed inwardly in an upper portion of the extending portion 21. The extending portion 21 has a tapered surface 21a which is a lower right surface and has an inclined surface that is inclined in a direction away from the light guide member 10 toward the back surface side. Therefore, the extending portion 21 has a tapered shape whose diameter decreases toward the back surface side.

The vertical wall 42 includes a base end portion 43 serving as a base end of the rising. The corner 12 of the light guide member 10 includes a fitting portion 13 that fits the extending portion 21 of the elastic member 20 at a position facing the base end portion 43. The fitting portion 13 has a shape that is recessed in a concave shape inside a plate surface of the light guide member 10 (in a direction in which the extending portion 21 extends). That is, a side end surface of the light guide member 10 is configured to have the fitting portion 13 having the recessed portion 13b that is recessed inward in the lower portion thereof and a protruding portion 13a that protrudes outward in the upper portion, so that the extending portion 21 of the elastic member 20 is fitted to the recessed portion 13b.

The elastic member 20 reaches the base end portion 43 and is press-fitted until it abuts on the bottom 41. By the elastic member 20 to elastically return between the base end portion 43 and the fitting portion 13, the extending portion 21 of the elastic member 20 is fitted with the recessed portion 13b of the fitting portion 13, and the recessed portion 28 of the elastic member 20 is fitted with the protruding portion 13a of the fitting portion 13.

Then, the effect of the present embodiment is described. The lighting device 1 according to the present embodiment includes the light source 30, the chassis (accommodating member) 40, the light guide member 10, and elastic member 20. The chassis 40 accommodates the light source 30. The chassis 40 includes the bottom 41 and the vertical wall 42 that projects from the edge of the bottom 41 on the front surface side. The light guide member 10 has the thin plate shape. The light guide member 10 is disposed on the front surface side of the bottom 41 and configured to guide the light emitted by the light source 30. The elastic member 20 having elasticity is disposed between the vertical wall 42 and the light guide member 10. The light guide member 10 has the fitting portion 13. The elastic member 20 is fitted to the fitting portion 13.

According to such a lighting device 1, when the lighting device 1 is manufactured, after the light guide member 10 is accommodated in the chassis 40, the elastic member 20 is press-fitted between the vertical wall 42 and the light guide member 10 and it becomes easy to fix the light guide member 10. Then, a relatively small elastic member 20 can be used, and the frame of the lighting device 1 can be narrowed. In addition, since the step of bringing the light guide member 10 into contact with the elastic member 20 and accommodating it in the chassis 40 becomes unnecessary, the position where the elastic member 20 is provided can be freely determined. Then, it becomes easy to design the lighting device 1 in a desired outer shape.

In addition, in the present embodiment, the light guide member 10 includes the fitting portion 13 that is recessed in the concave shape inside the surface. According to such a lighting device 1, it is difficult for the elastic member 20 disposed between the vertical wall 42 and the light guide member 10 to come off. Then, the light guide member 10 can be suitably accommodated in the chassis 40.

In addition, in the present embodiment, the portion of the elastic member 20 on a back surface side has a tapered shape. According to such a lighting device 1, when the lighting device is manufactured, it becomes easy to press-fit the elastic member 20 between the vertical wall 42 and the light guide member 10.

In addition, in the present embodiment, the light guide member 10 includes the convex portion 11 protruding toward the light source 30, and the elastic member 20 is disposed on the opposite side of the convex portion 11. According to such a lighting device 1, a main body of the light guide member 10 (the portion other than the convex portion 11 in the light guide member 10) can be suitably fixed to the chassis 40 by the convex portion and the elastic member 20 disposed on the opposite side of the convex portion 11. Thereby, even if the lighting device 1 receives an impact from the outside, it is possible to prevent the light guide member 10 from hitting the light source 30 and damaging the light source 30. In addition, the number of elastic members 20 can be reduced, and the cost can be reduced.

### Second Embodiment

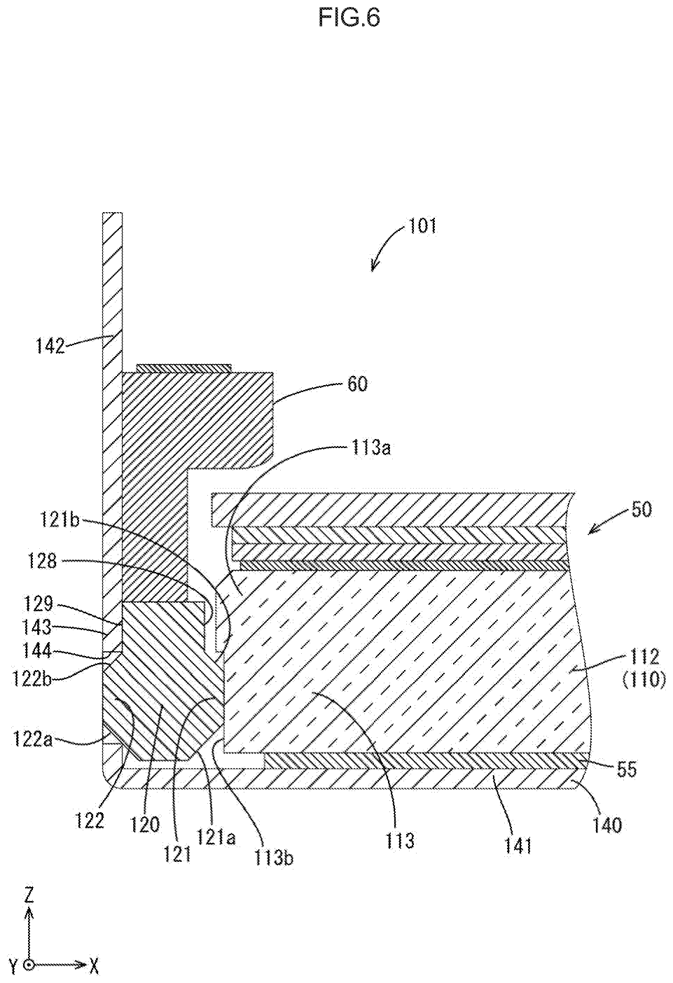

Next, second embodiment will be described with reference to FIG. 6. In the present embodiment, a lighting device 101 having a configuration of an elastic member and a chassis different from that of the first embodiment is illustrated. It is noted that in the present embodiment, the same reference symbols are used for the same parts as those in the above-described embodiment, and redundant description of the structure, operation, and effect is omitted.

On a back surface side of an elastic member 120 (a bottom 141 side of a chassis 140), a first extending portion 121 extending toward the inside of corner 112 of a light guide member 110 and a second extending portion 122 extending toward a vertical wall 142 side of the chassis 140 are disposed.

The elastic member 120 has a first recessed portion 128 that is recessed inwardly in an upper portion of the first extending portion 121. The first extending portion 121 has a lower right tapered surface 121a which is a lower right surface and has an inclined surface that is inclined in a direction away from the light guide member 110 toward the back surface side, and an upper right tapered surface 121b which is an upper right surface and has an inclined surface that is inclined in a direction away from the light guide member 110 toward the front surface side.

The elastic member 120 has a second recessed portion 129 that is recessed inwardly in an upper portion of the second extending portion 122. The second extending portion 122 has a lower left tapered surface 122a which is a lower left surface and has an inclined surface that is inclined in a direction away from the vertical wall 142 toward the back surface side, and an upper left tapered surface 122b which is an upper left surface and has an inclined surface that is inclined in a direction away from the vertical wall 142 toward the front surface side.

Therefore, the elastic member 120 has a shape in which a portion of a slightly back surface side from the center is swollen in the X-axis direction by the first extending portion 121 and the second extending portion 122. Then, the elastic member 120 has a tapered shape in which a diameter decreases from the portion of the slightly back surface side from the center to the front and back surface sides.

The vertical wall 142 includes a base end portion 143 serving as a base end of the rising. The base end portion 143 includes a hole (fitting portion) 144 drilled through the base end portion 143 in the thickness direction (X-axis direction).

A corner 112 of the light guide member 110 includes a fitting portion 113 that fits the first extending portion 121 of the elastic member 120 at a position facing the hole 144. The fitting portion 113 has a shape that is recessed in a concave shape inside a plate surface of the light guide member 110 (in a direction in which the first extending portion 121 extends). That is, a side end surface of the light guide member 110 is configured to have the fitting portion 113 having a recessed portion 113b that is recessed inward in the lower portion thereof and a protruding portion 113a that protrudes outward in the upper portion, so that the first extending portion 121 of the elastic member 120 is fitted to the recessed portion 113b.

The elastic member 120 is press-fitted until reaching the base end portion 143. By the elastic member 120 to elastically return between the base end portion 143 and the fitting portion 113, the first extending portion 121 of the elastic member 120 is fitted with the recessed portion 113b of the fitting portion 113, and the first recessed portion 128 of the elastic member 120 is fitted with the protruding portion 113a of the fitting portion 113. In addition, the second extending portion 122 of the elastic member 120 is fitted with the hole 144 of the base end portion 143.

Then, the effect of the present embodiment is described. In the lighting device 101 according to the present embodiment, the vertical wall 142 has the hole (fitting portion) 144 drilled through the vertical wall in the thickness direction.

According to such a lighting device 101, it is difficult for the elastic member 120 disposed between the vertical wall 142 and the light guide member 110 to come off. In addition, since a jig or the like can be inserted into the hole 144 from the outside of the chassis 140, the elastic member 120 can be easily removed from the hole 144 when the lighting device 101 is repaired.

<First Modification>

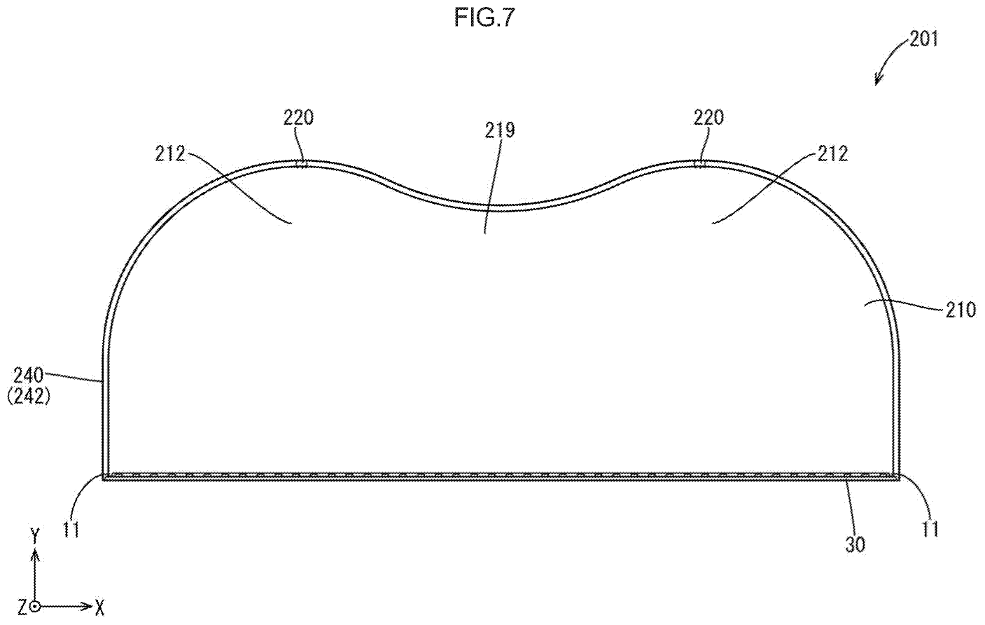

Next, a first modification will be described with reference to FIG. 7. In this section, a lighting device 201 having a different outer shape from the above embodiment is illustrated. It is noted that in the present embodiment, the same reference symbols are used for the same parts as those in the above-described embodiment, and redundant description of the structure, operation, and effect is omitted.

The lighting device 201 has an outer shape swelled from a long side extending in the X-axis direction to the upper left side and the upper right side on the lower side, and having a central portion recessed downward. The light guide member 210 has a shape that is long in the X-axis direction, and has swelling portions 212 and 212 that swell at two places in the Y-axis direction. Between the two swelling portions, a recessed portion 219 which is recessed in a direction opposite to a swelling direction of the swelling portions 212 and 212 is disposed. That is, the upper side of the light guide member 210 (opposite side of the light source 30) has an outer shape forming round shape such as undulation. The chassis 240 has a shape that is slightly larger than the light guide member 210 while following the outer shape of the light guide member 210.

The elastic members 220 and 220 are respectively disposed one by one between the upper left swelling portion 212 of the light guide member 210 and an upper left vertical wall 242, and between the upper right swelling portion 212 of the light guide member 210 and an upper right vertical wall 242.

<Second Modification>

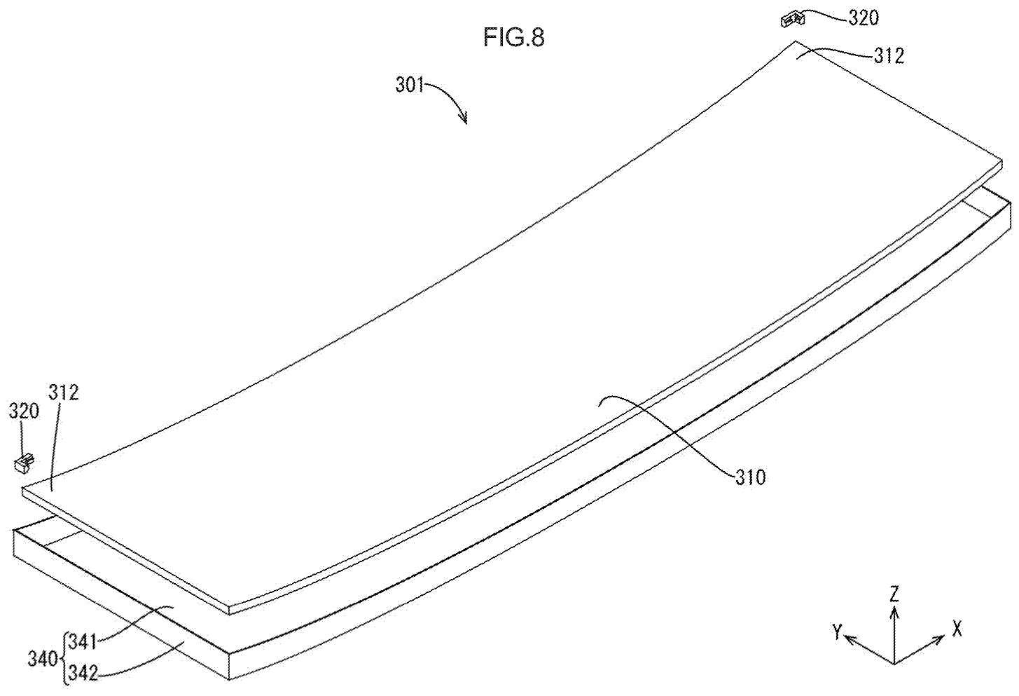

Next, a second modification will be described with reference to FIG. 8. In this section, a lighting device 301 having a different shape from the above embodiment and the modification is illustrated. It is noted that in the present embodiment, the same reference symbols are used for the same parts as those in the above-described embodiment, and redundant description of the structure, operation, and effect is omitted.

The lighting device 301 has a rectangular shape in plan view, and has a curved plate shape that is bent to the back surface side toward the central portion in the longitudinal direction (X-axis direction). Similarly, a light guide member 310 and a chassis 340 have a rectangular shape in plan view, and have a shape that is bent to the back surface side toward the central portion in the longitudinal direction.

Elastic members 320 and 320 are respectively disposed one by one between an upper left corner 312 of a light guide member 310 and an upper left vertical wall 342, and between an upper right corner 312 of the light guide member 310 and an upper right vertical wall 342. The elastic members 320, 320 are L-shaped in plan view so as to follow the corner 312 of the light guide member 310.

<Other Embodiments>

The technology described herein is not limited to the embodiments described with reference to the above description and drawings, and for example, the following embodiments are also included in the technical scope of the technology described herein, and further, in addition to the following, various modifications can be made without departing from the scope of the invention.

(1) In addition to the embodiment described above, the number of elastic members can be changed as appropriate. In the embodiment described above, the number of elastic members is two, but is not limited thereto and may be three or more. For example, in the lighting device 1 according to the first embodiment, a third elastic member may be press-fitted between a portion swelled above the light guide member 10 and the vertical wall 42.

(2) In addition to the embodiment described above, the configuration of the light guide member can be changed as appropriate. In the embodiment described above, the light guide member has the convex portion which protrudes toward the light source side in the lower right portion and the lower left portion, but is not limited thereto. For example, the light guide member may not have the convex portion, and the spacer members may be disposed between the lower right portion and the lower left portion of the light guide member and the vertical wall of the chassis. That is, the space may be provided between the light guide member and the LED by the spacer member.

(3) The lighting device illustrated in the embodiment described above is not limited to that provided for a liquid crystal display device provided in an inner panel for a vehicle. For example, the lighting device can also be applied to a liquid crystal display device provided in a television receiver, a portable information terminal, or the like.

1. A lighting device comprising:
a light source;
an accommodating member accommodating the light source, the accommodating member including a bottom and a vertical wall projecting from an edge of the bottom on a front surface side of the bottom;
a light guide member having a thin plate shape, the light guide member being disposed on the front surface side of the bottom and configured to guide light emitted by the light source; and
an elastic member having elasticity and disposed between the vertical wall and the light guide member, wherein
at least one of the vertical wall and the light guide member includes a fitting portion, and
the elastic member is fitted to the fitting portion.

2. The lighting device according to claim 1, wherein the light guide member includes the fitting portion that is recessed in a concave shape inside a plate surface.

3. The lighting device according to claim 1, wherein the vertical wall includes the fitting portion that includes a hole drilled through the vertical wall in a thickness direction.

4. The lighting device according to claim 1, wherein at least a portion of the elastic member on a back surface side of the elastic member has a tapered shape.

5. The lighting device according to claim 1, wherein
the light guide member includes a convex portion protruding toward the light source, and
the elastic member is disposed on an opposite side from the convex portion.
